(19) United States
(12) Patent Application Publication
(10) Pub. No.: US 2018/0060848 A1
(43) Pub. Date: Mar. 1, 2018

(54) TEXT-ENABLED POINT-OF-SALE SYSTEM

(71) Applicants: ALI HUSAIN, NORTHVILLE, MI (US); MICHAEL COCHRAN, DEXTER, MI (US); HAARIS AHMAD, CANTON, MI (US)

(72) Inventors: ALI HUSAIN, NORTHVILLE, MI (US); MICHAEL COCHRAN, DEXTER, MI (US); HAARIS AHMAD, CANTON, MI (US)

(21) Appl. No.: 15/685,819

(22) Filed: Aug. 24, 2017

Related U.S. Application Data
(60) Provisional application No. 62/380,380, filed on Aug. 27, 2016.

(51) Int. Cl. G06Q 20/20; G06Q 20/16; G06Q 20/32; G06Q 30/02; G06F 3/0481; G06F 3/0482; G06F 3/0488

(52) U.S. Cl. CPC G06Q 20/20; G06Q 20/16; G06Q 20/322; G06F 3/04883; G06Q 30/0269; G06F 3/04817; G06F 3/0482; G06Q 30/0255

(57) ABSTRACT

The present invention is a retail or restaurant point-of-sale (“POS”) system that is text-message enabled. The present invention includes typical POS functionality such as menu and product configuration, order creation, order submission, and payment processing. The system enables customer service from the point-of-sale system through text messaging. The system can also import, directly, text via text message or email, into the order screen of the POS system.

### FIELD OF INVENTION

This invention relates to the class of data processing: financial, business practice, management, or cost/price; and to one or more sub-classifications for electronic shopping, or restaurants. Specifically, this invention relates to text enabled point of sale (“POS”) systems.

### BACKGROUND OF INVENTION

Text messaging has burgeoned since its inception in the 1990's. In 2015, users were sending 23 billion text messages per day or 16 million text messages per minute. This totaled over 8 trillion text messages for the year 2015. Text messaging is ubiquitous, and continues to grow. Millennials and post-Millennials (aka Generation Z) use text messaging as their primary form of communication. It is not surprising, then, that messaging has become the most preferred method of communication both globally and in the United States. More people in the United States communicate over text message than over email or phone. What is surprising is that this messaging phenomenon is growing beyond just personal use.

Many new platforms such as WhatsApp®, Viber®, Line®, and Snapchat® are dedicated to enabling text messaging. Younger users are looking for technologies which further enable their use of text messaging to perform day-to-day tasks. Many new platforms such as WhatsApp

Recent surveys show consumers increasingly desire to receive customer service by text message. Specifically, the surveys reported that 81% of adults in America are fatigued with phone and online customer service, and 64% would rather text than talk to a company.

Simultaneously, Americans are placing over 2 billion food delivery orders per year. For the 600,000 plus restaurant establishments in the United States, text messaging is both a blessing and a curse. Text messaging allows platform-agnostic communications. Allowing customers to text message order allows restaurants enjoy incremental sales without having to talk on the phone, which is especially encourages patronage from Millennials and post-Millennials. Unfortunately, the text messages must be responded to, still requiring an order-taking. Additionally, the orders often have to be manually entered into the establishment's separate POS system. During a busy lunch rush, manually responding to text messages and entering them into a POS system is fraught with mistake. Someone has to correlate the text message orders with the POS system orders. This often leads to missed orders and angry customers.

What the market needs is a way to allow text messaging to interoperate with the POS system. Such a system should work regardless of the text messaging application. Such a system should automate response and order entry to the maximum allowable extend. Currently, no such system exists.

### SUMMARY OF THE INVENTION

This summary is intended to illustrate and teach the present invention, and not limit its scope or application. The present invention is a text-enabled POS system that allows a traditional POS system to interoperate with non-encoded alphanumeric text messages.

A customer has a customer device such as a cellphone that is text message enabled. The customer device has a screen, a processor, a memory element, an input, a communication means, and software that enables it to at least send and receive text messages. The software is stored on the memory element in a computer-readable, non-transitory state. The customer sends a text message to a retail establishment that uses a POS system, such as the restaurant. The text message contains an order. The text message can be communicated to the restaurant through a cellular network, the internet, a satellite network, or a combination of all of the above. The present invention is a text-enabled POS system. The text-enabled POS system has a messaging application protocol interface (“API”), a POS API, a POS Device, a POS database, and host server. The POS database, in reality, would be a database and server, either physically combined or separate but interoperating. The host server would allow client POS systems to use an occurrence of the software. The host server could aggregate order data across establishments, allowing for a single customer to have an order summary that consolidates the information from a plurality of establishments. At a minimum, a customer is provided with an order history for each establishment.

The messaging API ingests the text message, containing an order, from the customer. The messaging API insures that incoming messages are properly formatted for the POS API. The messaging API also insures that outgoing messages are properly formatted text messages. The messaging API identifies the non-encoded alphanumeric text. The messaging API can also identify and handle approved media such as pictures and QR symbols. For example, the customer may send a menu picture of what he wants, a coupon, or a QR code along with standard text. The messaging API creates a redirect message containing the non-encoded, alphanumeric text and any compatible media and sends it to the POS API. The POS API takes the redirect message and sends it to the POS database and server to associate with a customer profile. The customer profile and history are returned by the POS database and server to the POS API. The customer profile, history, and the current order embedded in the redirect message are loaded in the POS device and a push notification is sent. If the original message, and therefore the redirect message, contain text that can be interpreted as an item order, an order can be loaded directly into the POS system and displayed on the POS device. The push notification alerts the restaurant that there is an incoming order.

The restaurant can respond to the order with text messages of its own through the POS device. The POS device has a screen that displays the graphic user interface (“GUI”) of the present invention. The POS system user enters the order contained in the text message into the POS system, using the GUI. The POS device returns the order summary, along with a payment request, to the POS API. The POS API requests a payment link from a payment process API. The payment processing system returns a payment link through its payment process API to the POS API. The POS API sends the payment link information and order summary back to the messaging API. The messaging API sends the order summary and payment link back to the customer in a properly formatted text message.

In parallel, the POS API stores the payment link information in the POS database and server, associating it with the customer's current order. The POS system associates the new order with the customer profile in the POS database and server.

The customer uses the payment link to provide payment information to pay for the order. The payment process API sends confirmation back to the POS system. The POS database and server associates the payment information with the customer's order and creates a payment confirmation. The payment confirmation is passed to the POS device and POS API. In this way, the order and payment process are completed prior to the customer arriving. In the event that the order is for deliver, the order and payment process can be confirmed complete prior to delivery.

The GUI allows a user to not only enter an order, but also conduct a text conversation with the customer. The GUI displays all active customers, meaning all customers with an order being processed. By selecting a current customer, the POS user displays the current customer's profile on the GUI. The profile includes basic information such as name, phone number and address. The profile also includes a widget to bring up the customer's prior orders. A widget is a graphically-represented control element, such as a button or slider.

The text conversation with the customer can be freeform text, or it can be composed from a set of common responses, called quick answers. The list of common responses can be shown as buttons on the GUI. Quick answers can also be entered with common abbreviations. For example, “del” can stand for “delivery.” The GUI allows the user to view the history of the current conversation with the current customer.

The GUI has a menu for ordering. In a restaurant environment, this would be the items on the restaurant's menu. The user would enter the customers order based off of the text conversation. Order entry would be through widgets representing each menu item. The user would hit “confirm” to enter the order in the POS system. The user could also print the order, if a receipt or restaurant chit is needed.

### BRIEF DESCRIPTION OF THE DRAWINGS

The present invention, a text enabled POS system, is illustrated with six drawings on six sheets.

FIG. 1 is a high-level flow chart of the present invention.

FIG. 2 is a front view of a text-enabled POS system.

FIG. 3 shows a process for allowing a customer to access all prior orders, regardless of merchant.

FIG. 4 is a chart showing quick answers examples.

FIG. 5 shows the type of data elements stored in the database and server associated with the present invention.

FIG. 6 is a system communication diagram.

### DETAILED DESCRIPTION OF THE DRAWINGS

The following descriptions are not meant to limit the invention, but rather to add to the summary of invention, and illustrate the present invention, a text-enabled POS system. The text-enabled POS system presented with the drawings is one potential embodiment.

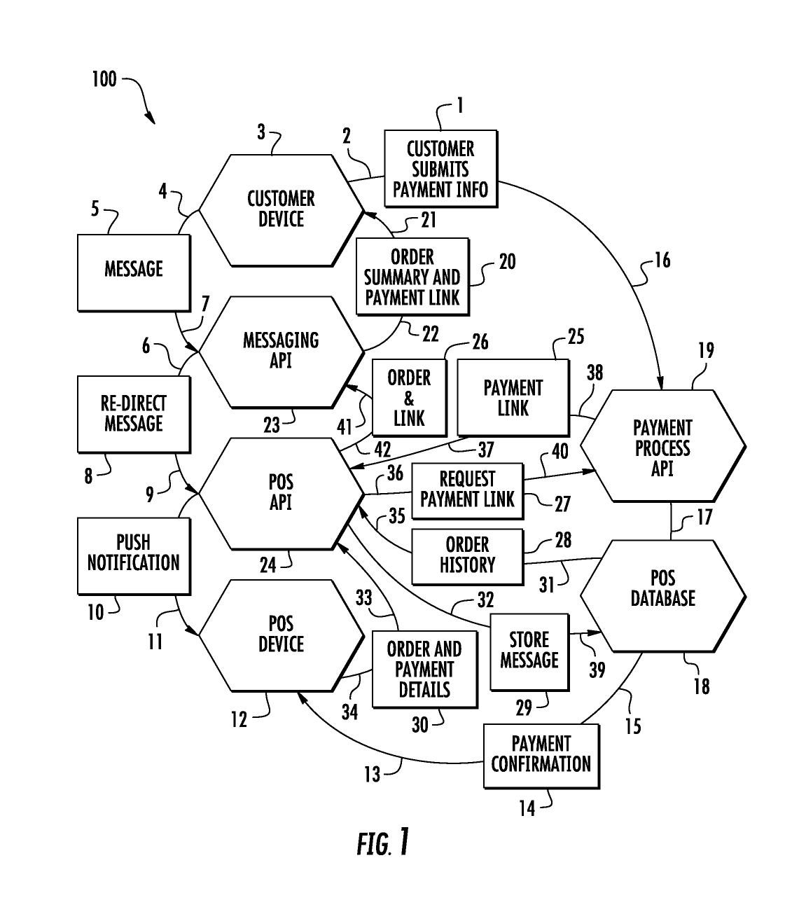

FIG. 1 is a high-level flow-chart of the present invention 100, a text-enabled POS system. The high-level flow-chart is accomplished with software, which is a computer readable instruction set stored on a non-transitory, computer-readable medium.

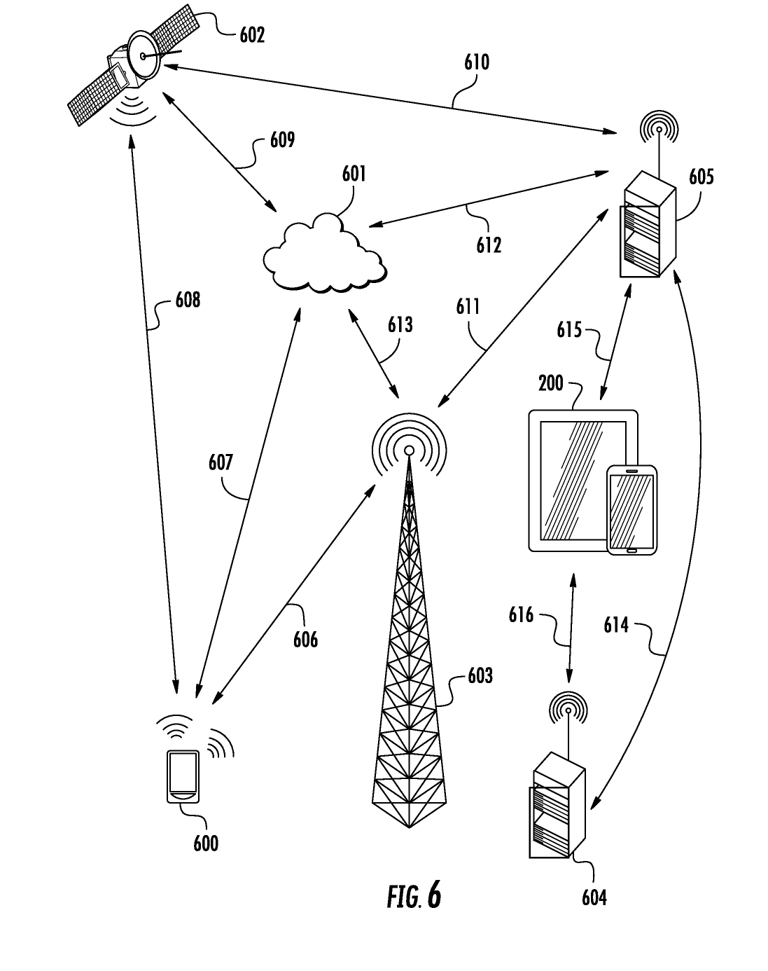

FIG. 6 is a high-level communication flow for the present invention 100. A customer device 600 has customer device software 3, stored on a tangible, persistent, non-transitory, and computer readable memory. The customer device 600 has a screen, a processor, an input, a communication means, and software 3 that at least enables it to send and receive text messages. The customer device software 3 allows the customer to send 4, 7, 608, 607, 606 and receive 21, 22, 608, 607, 606 non-encoded alphanumeric text messages, commonly referred to as texts. The texts can be short message service (SMS) format or other text platforms (e.g., WhatsApp®, Facebook Messenger®).

The customer device 600 can communicate with a POS database and server 605, running an occurrence of the present invention's 100 software, by sending communications through a communication network. Among the common communication networks in use, currently, are a cellular network 603, 606, 611, a communications network connected through the internet 607, 601, 612, a communications network connected through a satellite network 608, 602, 610, or a communications network connected through a combination of all of the above 601, 602, 600, 606, 607, 608, 609, 610, 611, 612, 613. When the term communication channel is used in this specification, it is referring to some combination of 601, 602, 603, 606, 607, 608, 609, 610, 611, 612, 613. The customer device 600 and customer device software 3 sends 601, 602, 603, 606, 607, 608, 609, 610, 611, 612, 613 a text to the POS database and server 605. The POS database and server 605 is connected 612, 613, 614, 615, 616 with a POS device 200 and a host server 604. A POS database and server 605 can be a separate server and database, or one physical device. The software expressing the present invention 100 is a computer readable instruction set stored on a non-transitory, computer-readable medium, such as the host server 604, the POS database and server 605, and/or a memory element of a POS device 200.

Referring back to FIG. 1, as with most electronics, the POS Device 12 has a device login and authentication routine. The customer has a customer device 600, 3 from which the customer can send 4, 7 text messages 5. It is assumed, though not required, that the customer device 600, 3 has a login and authentication, also. The customer sends 4, 7 a message 5, containing a non-encoded, alphanumeric string. The message 5 makes a purchase request, such as an order from a restaurant. The text message 5 is received by the messaging application protocol interface (“API”) 23. The messaging API 23 verifies that the text message 5 is a non-encoded, alphanumeric text. If the text message 5 contains non-text elements, such as a picture, portable document format (“pdf”) document, XML document, or other communicative media, the messaging API strips off the text and any authorized media, so that it may be resent 6, 9 as a format-verified text message 8. Authorized media may be pictures that a store or restaurant posts of an item for sale, a QR code, or other pre-defined embedded object. The messaging API 23 routes 6, 9 the redirect message 8 to the POS API 24. The POS API 24 processes the redirect message 8, discerning what is to be order from the non-encoded, alphanumeric text.

The POS API 24 sends 32, 39 the stored message 29 to the POS database and server 18. The POS database and server 18 is an assemblage of memory elements and processing units that allow input and output of data. The POS database and server 18 is accessible through a communications channel, such as the internet 607, 601, 612 or a dedicated network connection. The POS database and server 18 ingests the message 29, and stores it with a customer record based on the customer device 600, 3 phone number or personal identifier. The POS database and server 18 creates an order history 28 for the customer and sends 31, 35 the order history 28 back to the POS API 24.

The POS API 24 loads the redirect message 8 and order history 28, and sends 9, 11 them via a push notification 10 to the POS Device 12. The POS Device 12 is a tablet, laptop, or other assembly of memory and processing elements that possesses a display screen. The customer's order embedded in the redirect message 8 and order history 28 are displayed on the screen of the POS device 12, using a GUI. The order history 28 necessarily includes the customer profile. A user of the POS device 12 can enter an order based off of the information in the redirect message 8 and order history 28. If the text of the redirect message 8 can be interpreted as an order of an item, the order will be placed in the POS device 12. When the user of the POS device 12 is finished with the order and presses “confirm”, the POS device 12 generates an order and payment details 30.

The customer device 3 can also send an e-mail message 5. The messaging API 23 can ingest text from an e-mail message 5, and create a re-direct message 8. If the text of the redirect message 8 created from the messaging API 23 ingesting an email message 5 can be interpreted as an order of an item, the order will be placed, automatically, in the POS device 12. By allowing text to be scrapped out of e-mail messages 5, the text-enabled POS system can interoperate with e-mails delivered by food delivery services such as Grubhub®

The POS device 12 sends 33, 34 the order and payment details 30 to the POS API 24. The POS API 24 generates a payment link request 27. The payment link request 27 is send via a communication channel 36, 40 to a payment process API 19. The payment process API 19 generates and sends a payment link 25, 38, 37 to the POS API 24. The POS API 24 creates a store message 29 with the payment link 25 and sends 32, 39 it to the POS database and server 18 to be associated with the customer's record. The POS API also combines the payment link 25 with the order and payment details 30 to create an order and payment link 26. The POS API 24 sends 42, 41 the order and payment link 26 to the messaging API 23. The messaging API 23 creates a properly formatted text message containing the order summary and payment link 20 and sends 22, 21 it to the customer device 3.

The customer device 3 uses the payment link 25 from the order summary and payment link 20 message to send 2, 16 payment information 1 to the payment process API 19. The payment process API 19 sends a payment confirmation 14 to the POS database and server 18. The POS database and server 18 takes the payment confirmation 14, matches it with correct order, and sends the payment confirmation 14 to the POS device 12. In this way, an order contained in an original message 5 can be processed prior to the customer arriving. In a restaurant setting, this would allow the restaurant to confirm the order 20, get payment 14 and prepare the food prior to the customer arriving.

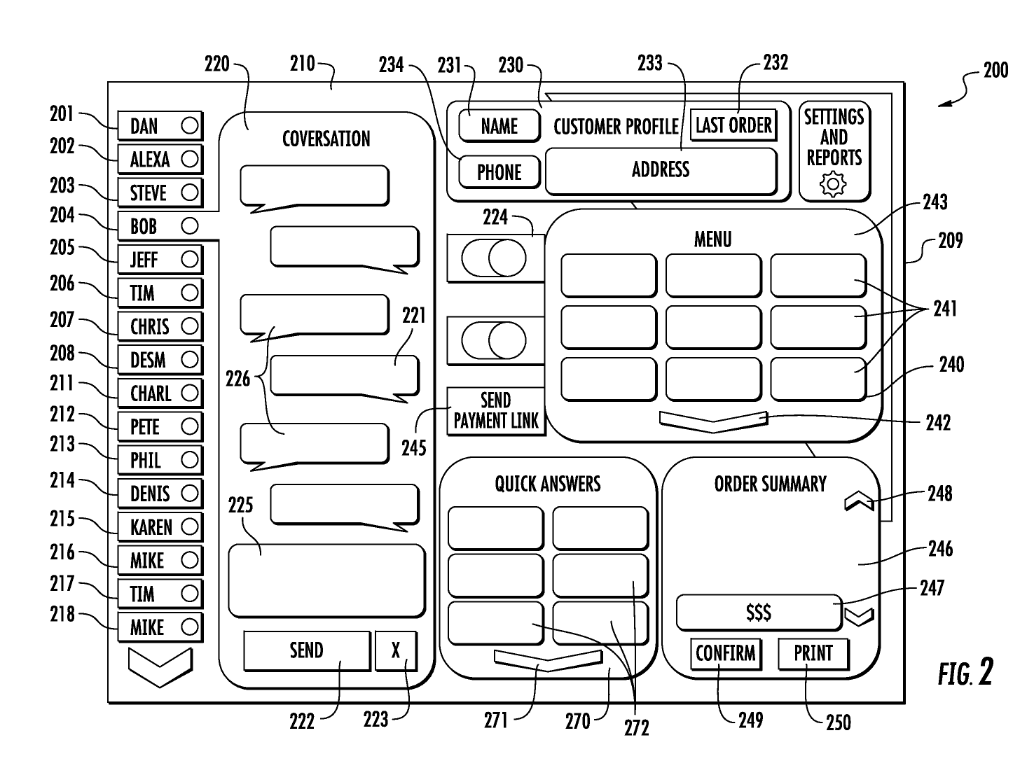

Referring to FIG. 2, a physical POS device 200 has a screen 210 and contains the POS device software 12 on a tangible, durable, non-transitory computer-readable medium. The POS device software 12 has a GUI. All the visible elements of FIG. 2, with the exception of the physical POS device 200 and the screen 210, are part of the GUI.

In this example, the implementation is for a restaurant. The POS device 200 screen 210 and software 12 show a plurality of active customers 201, 202, 203, 204, 205, 206, 207, 208, 209, 210, 211, 212, 213, 214, 215, 216, 217, 218, meaning customers with an active order that was received through the push notification 10.

The display 210 shows the current customer's 204 profile 230. The profile 230 is composed of the customer's name 231, phone 234, address 233. The profile 230 also allows a user to see a customer's last order 232.

The POS device 200 GUI shows a conversation 220 with a single current customer 204. The conversation 220 is composed of plurality of sent text messages 226 and received text messages 221 constituting the current order 5, 20. A user can enter text 225 from the merchant side and send 222 or cancel 223 the message.

The display 210 has a quick answer 270 block. The quick answer block 270 is composed of common responses 272 to the ordering process to reduce typing. The quick answer block 270 has a widget 271 to load the next logical portion of common answers 272.

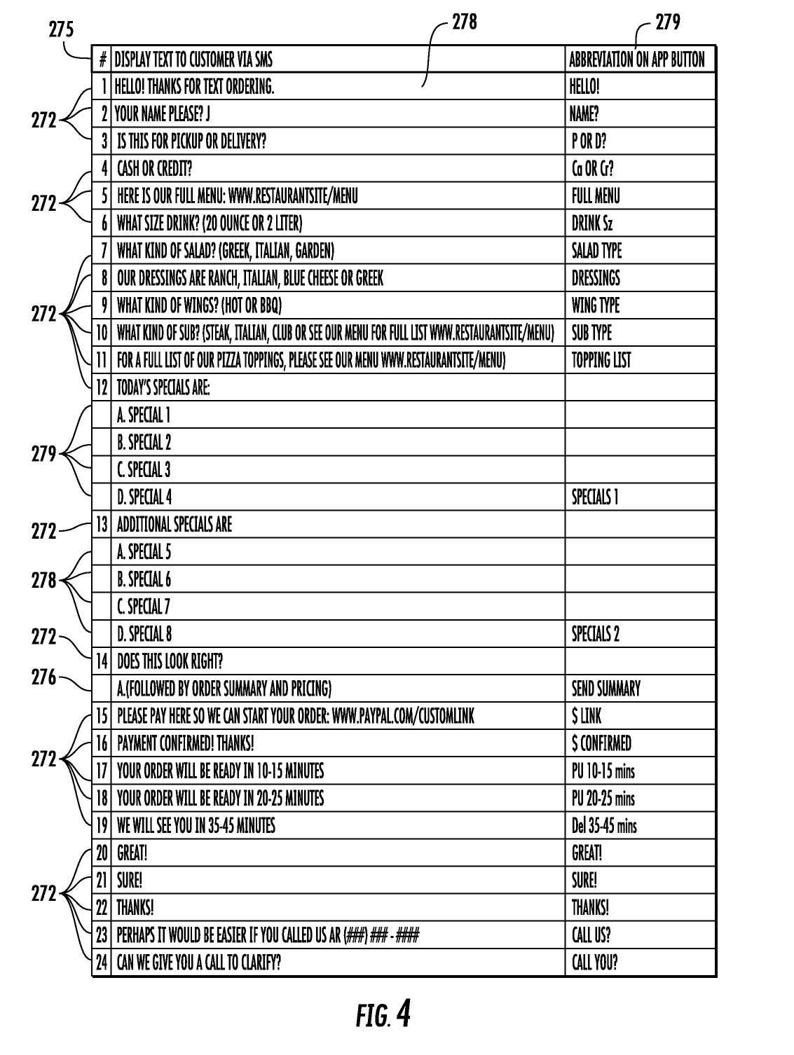

FIG. 4 shows an example of possible quick answers 272. Each quick answer 272 has a display text 278 and an abbreviation for typing 279. Certain quick answers may have nesting 278, 279 requiring additional order entry.

Referring back to FIG. 1, based off of the conversation 220, including quick answers 272, a user can enter menu items into the point-of-sale system. The POS device 200 screen 210 shows the menu 243. The menu is composed of a plurality of items 241. A widget 242 loads the next logical part of the menu 243. When the last item 240 is highlighted, hitting the down key on a keyboard will perform the same function as the widget 242. The order summary 246 shows the current status of the order. The order summary 246 has widgets 247, 248 which allow the user to scroll through the order. The order summary 246 takes input from the menu 243. Once the order is complete, the user hits confirm 249. If a receipt is needed, or if a restaurant chit is needed, a print 250 button allows a receipt printer to print the order.

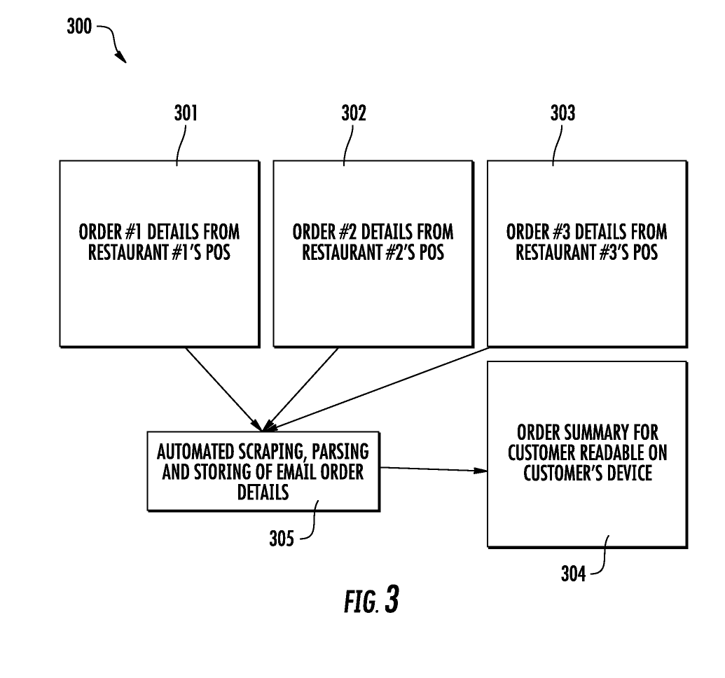

FIG. 3 shows a process 300 for creating a customer order history 304 viewable on the customer's device 600. As orders 301, 302, 303 are completed from a plurality of restaurants, an automated scraping, parsing and storing 305 routine captures the of the order details. These are saved so that the customer has an order summary 304 from all venues that is viewable on the customer's device 600.

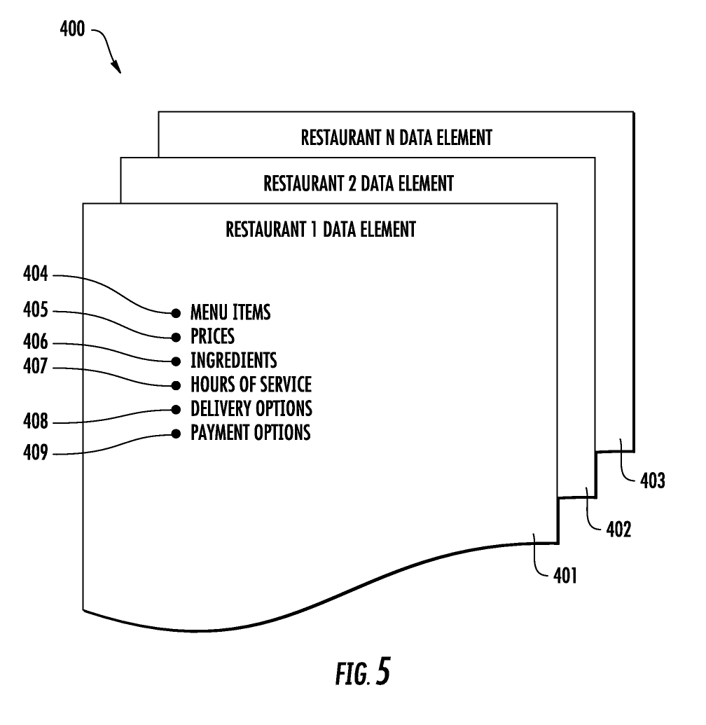

FIG. 5 shows how data 400 is stored for each retail establishment or restaurant. Each restaurant has its own data table 401, 402, 403. Each data table 401, 402, 403 contains data elements 404, 405, 406, 407, 408, 409. For example, for a restaurant 401, the data elements might be menu items 404, prices 405, ingredients 406, hours of service 407, delivery options 408, and payment options 409.

We claim:

1. A text-enabled point-of-sale (“POS”) system comprising
at least one customer device, comprised of a processor, a memory element that has a first non-transitory computer readable medium, an input means, a communication means, and customer device software that enables the customer device to send and receive non-encoded, alphanumeric messages (“text messages”);
a host server comprised of a memory element that has a second non-transitory computer readable medium, a processor, a communication means, and a computer readable instruction set, called a software application, that is resident on the second non-transitory computer readable medium;
a POS database and server comprised of a memory element that has a third non-transitory computer readable medium, a processor, and a communication means, wherein the POS database and server can communicate with the at least one customer device, can execute an occurrence of the software application over the communication means; and can store a plurality of data records;
a POS device comprised of a screen, a processor, a memory element that has a fourth non-transitory computer readable medium, a communication means, and a computer readable instruction set called a graphic user interface, stored on the fourth non-transitory computer readable medium, that allows for the input of orders and the exchange of text messages;
wherein the software application is comprised of a POS application protocol interface (“API”) and a messaging API; and
wherein the software application executing on the POS database and server can receive a text message containing a non-encode alphanumeric order from the at least one customer device;
use the messaging API to insure that the text message is in a pre-defined format;
generate a redirect message, containing, at a minimum, the unencoded alphanumeric text of the text message;
transmit the redirect message to the POS API
transmit the redirect message to the POS server and database and identify a data record containing an order history corresponding to the at least one customer device associated with the redirect message, on the third non-transitory medium;
add the redirect message to the data record corresponding to the at least one customer device associated with the redirect message;
transmit the data record of the order history to the POS API;
push the redirect message and the order history from the POS API to the GUI on the POS device, wherein a push notification notifies a user of the POS device that a new order has arrived; and
generate an order, and order summary, including a payment amount.

2. The text-enabled POS system of claim 1 in which an order is manually entered by the POS device user based off of the input of the text message from the at least one customer device.

3. The text-enabled POS system of claim 1 in which an order is automatically loaded onto the POS device based off of the non-encoded alphanumeric text contained in the redirect message.

4. The text-enabled POS system of claim 1 in which the at least one customer device is a cellphone.

5. The text-enabled POS system of claim 1 in which the at least one customer device is an e-mail server.

6. The text-enabled POS system of claim 5 in which the text message is an e-mail.

7. The text-enabled POS system of claim 1, wherein a user of the POS device can compose a text message on the GUI, in response to the at least one customer's text message.

8. The text-enabled POS system of claim 7, wherein a user of the POS device can enter an order based off of the at least one customer's text message.

9. The text-enabled POS system of claim 8, wherein the text history related to a single order can be displayed on the GUI as a conversation.

10. The text-enabled POS system of claim 1, wherein the data record further contains a customer profile.

11. The text-enabled POS system of claim 10, wherein the customer profile contains a preferred payment processor.

12. The text-enabled POS system of claim 11, wherein the POS API can request a payment link for the payment amount from the preferred payment processor associated with the customer profile.

13. The text-enabled POS system of claim 12, wherein the POS API can receive a payment link for a payment amount from the preferred payment processor associated with the customer profile.

14. The text-enabled POS system of claim 13, wherein the POS API transmits the order summary and payment link to the messaging API.

15. The text-enabled POS system of claim 14, wherein the messaging API transmits the order summary and payment link to the at least one customer device.

16. The text-enabled POS system of claim 15, wherein the customer can make payment for the order using the payment link.

17. The text enabled POS system of claim 16, wherein a payment confirmation is transmitted to the POS system.

18. The text enabled POS system of claim 17, wherein the payment confirmation is matched with the order and is displayed on the GUI.

19. The text enabled POS system of claim 1, wherein the host server collects order history from a plurality of establishments and aggregates the order history for each establishment for each customer.

20. The text enabled POS system of claim 1, wherein the host server stores a data record for each establishment with a text-enabled POS system.

21. The text enabled POS system of claim 20, wherein each data record for each establishment is comprised of the name of the establishment, the location of the establishment, the hours of service of the establishment, the forms of payment accepted by the establishment, and a list of all goods and services for sale by the establishment.
